(19) United States
(12) Patent Application Publication
(10) Pub. No.: US 2003/0074241 A1
(43) Pub. Date: Apr. 17, 2003

(54) Online shipment information server system and method for providing shipment information to freight forwarder

(76) Inventors: Yi-Ming Liao, Taipei (TW); Cheng-Ju Chen, Taipei (TW); Yun-Chi Lee, Taipei (TW)

Correspondence Address: ROTHWELL, FIGG, ERNST & MANBECK, P.C., 1425 K STREET, N.W., SUITE 800, WASHINGTON, DC, 20005, US

(21) Appl. No.: 09/974,912

(22) Filed: Oct. 12, 2001

(51) Int. Cl. G06F 17/60

(52) U.S. Cl. 705/7

(57) ABSTRACT

An online shipment information server system and method is proposed, which allows a manufacturer to provide online shipment information, including EDI855-related information, delivery-related information, and EDI856-related information, to a freight forwarder in real time so as to allow the freight forwarder to prepare the required customs/exportation documents for the shipment of the manufacturer-consigned freight to a foreign country. The proposed online shipment information server system and method allows the freight forwarder to receive online shipment information in real-time via Internet, without having to be mailed or faxed by the manufacturer to the freight forwarder, thereby allowing the freight forwarder to execute the required custom/exportation application procedures more efficiently and reliably.

### BACKGROUND OF THE INVENTION

1. Field of the Invention

This invention relates to information technology, and more particularly, to an online shipment information server system and method which can be used by a manufacturer to provide online shipment information to a freight forwarder for the freight forwarder to prepare customs/exportation documents in real time before the freight is handed to the freight forwarder.

2. Description of Related Art

As a manufacturer completes the production for a purchase order from a customer residing in a foreign country, it is a common practice to contract a freight forwarder for shipment of the customer-ordered products to the overseas customer. To fulfill this contract, the freight forwarder must prepare and submit related customs/exportation documents to the customs/exportation authorities before it can transport the manufacturer-consigned products to the overseas customer. The preparation of these customs/exportation documents is based on a set of shipment information provided by the manufacturer.

Traditionally, the required shipment information for the freight forwarder to prepare the customs/exportation documents is sent to the freight forwarder via mails or faxes. One drawback to this practice, however, is that it is quite time-consuming and laborious and would not allow the freight forwarder to get the shipment information in real time, thus making the overall shipment procedure quite inefficient and unreliable.

### SUMMARY OF THE INVENTION

It is therefore an objective of this invention to provide an online shipment information server system and method which allows the freight forwarder to receive the required shipment information in real-time via Internet, without having to be mailed or faxed by the manufacturer to the freight forwarder, so as to allow the freight forwarder to execute the freight forwarding task more efficiently and reliably.

The online shipment information server system and method according to the invention allows a manufacturer to provide online shipment information to a freight forwarder in real time so as to allow the freight forwarder to prepare and submit the required customs/exportation application documents well in advance before the shipment of the customer-order products.

The online shipment information server system and method according to the invention utilizes a Web-linked database for storing all the shipment information at each stage of shipment preparation, including EDI855-related information, delivery-related information, and EDI856-related information, allowing the freight forwarder to view the shipment information through a Web browser program and print the shipment information into a set of customs/exportation application documents. Since the freight forwarder can receive online shipment information in real-time via Internet, without having to be mailed or faxed by the manufacturer to the freight forwarder, the invention allows the freight forwarder to execute the required custom/exportation application procedures more efficiently and reliably.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the online shipment information server system according to the invention; and

FIG. 2 is a flow diagram showing the procedural steps performed by the online shipment information server system according to the invention

### DETAILED DESCRIPTION OF PREFERRED EMBODIMENTS

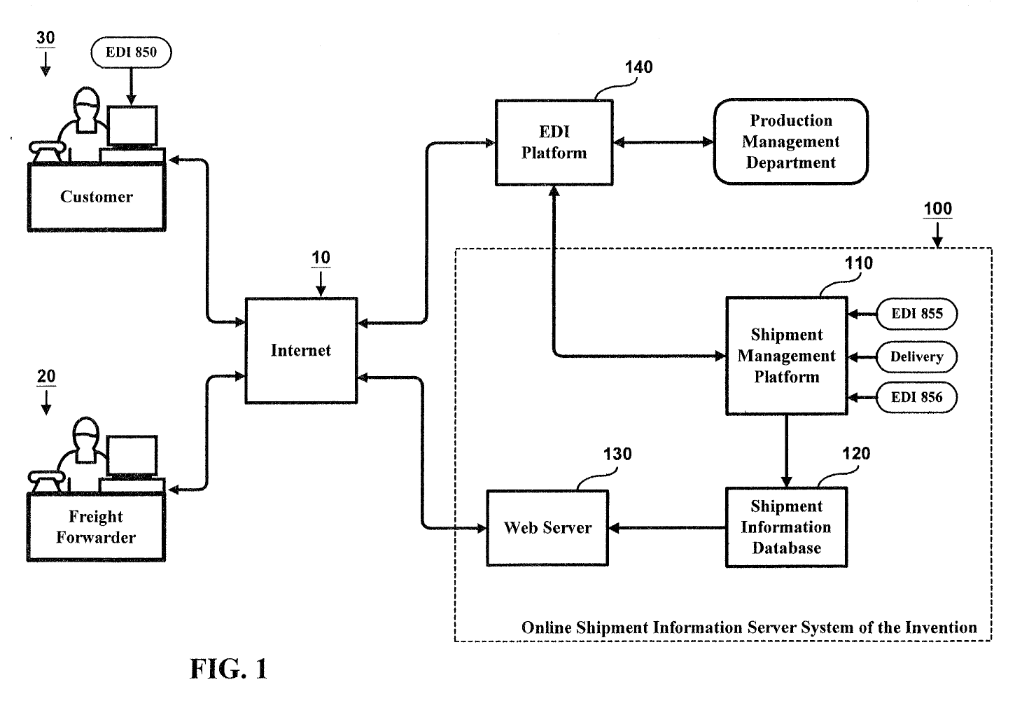

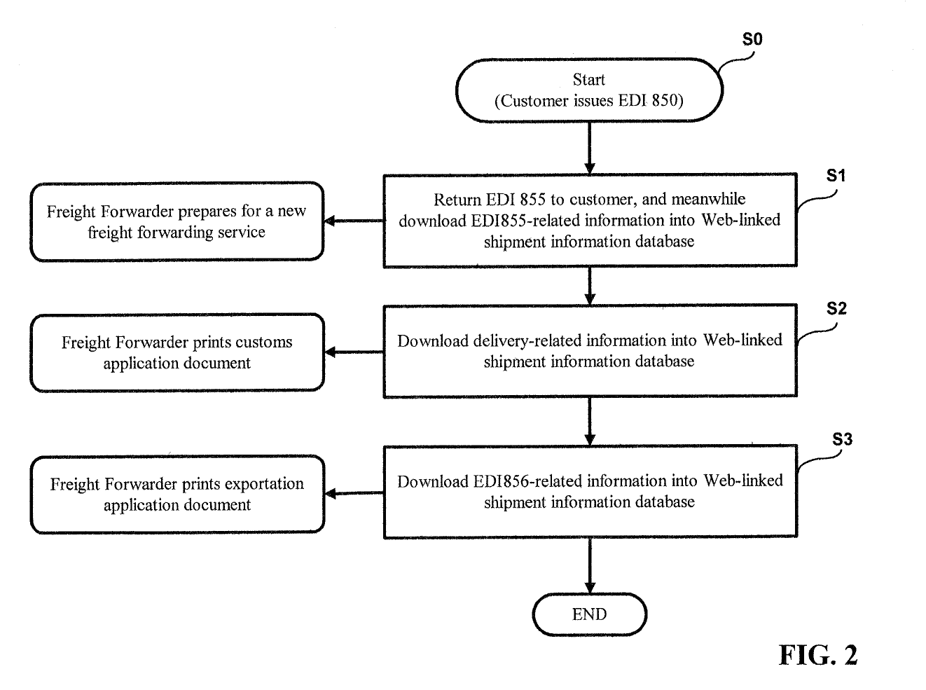

The online shipment information server system and method for providing online shipment information to a freight forwarder according to the invention is disclosed in full details in the following with reference to FIG. 1 and FIG. 2.

FIG. 1 is a schematic diagram showing the system architecture of the online shipment information server system according to the invention (which is the part enclosed in the dashed box indicated by the reference numeral 100). As shown, the online shipment information server system 100 of the invention is installed as part of the electronic business information system at a manufacturer site, for the purpose of allowing the manufacturer to provide online shipment information to a freight forwarder 20 when customer-order products are to be consigned to the freight forwarder 20 for shipment to the customer 30.

The online shipment information server system 100 of the invention is externally linked to a network system, such as Internet 10, and internally linked to an EDI platform 140 used to receive electronic purchase orders (such as EDI850) via Internet 10 from the customer 30.

The online shipment information server system 100 of the invention comprises: (a) a shipment management platform 110; (b) a shipment information database 120; and (c) a network server, such as a Web server 130.

The shipment management platform 110 is a computer unit, such as a desktop PC, which allows the manufacturer's shipment management personnel to build and manipulate a set of shipment information that is required for the freight forwarder 20 to prepare customs/exportation documents, including EDI855-related information (purchase order acknowledgement), delivery-related information, EDI856-related information (shipment notification), and so on.

The shipment information database 120 is a database site used to store all the shipment information prepared by the shipment management platform 110. At each stage of shipment preparation, the shipment management personnel are required to use the shipment management platform 110 to prepare and download all the related shipment information into the shipment information database 120. Details of the procedural steps will be later described in reference to FIG. 2

The Web server 130 is externally linked to Internet 10 and internally linked to the shipment information database 120, for serving up the shipment information downloaded in the shipment information database 120 via Internet 10 to the freight forwarder 20, allowing the freight forwarder 20 to view and utilize the shipment information through a browser program, such as Microsoft Internet Explorer or Netscape Navigator.

The EDI platform 140 is based on the EDI (Electronic Data Interchange) standard and is externally linked to the Internet 10 for transferring and receiving EDI-compliant business transaction forms to and from the customer 30. Since the EDI standard is well-known in the information industry, description thereof will not be further detailed.

FIG. 2 is a flow diagram showing the procedural steps performed by the online shipment information server system 100 of the invention for providing online shipment information to the freight forwarder 20 in response to an electronic purchase order EDI850 from the customer 30.

As shown, at the initial step SO, the customer 30 issues an electronic purchase order EDI850 via the Internet 10 to the manufacturer. The customer-issued EDI850 form is received by the EDI platform 140 which then initiates the online shipment information server system 100 of the invention to perform the subsequent steps S1-S3 (note that the received EDI850 is also forwarded to other related departments, such as production management department; but since these procedures are not within the spirit and scope of the invention, description thereof will not be further detailed).

In the first step S1, the shipment management platform 110 returns an EDI855 form (Purchase Order Acknowledgement) via the EDI platform 140 and the Internet 10 to the customer 30 to acknowledge the reception of the customer-issued EDI850, and meanwhile downloads EDI855-related information to the shipment information database 120. Since the shipment information database 120 is linked to the Web server 130, it allows the freight forwarder 20 to promptly receive the EDI855-related information and thereby prepares well in advance for a forthcoming new freight forwarding service to the manufacturer to help the manufacturer to transport the customer-ordered products to the customer 30.

When delivery is ready, the next step S2 is executed, in which the shipment management platform 110 is used to prepare and download all the delivery-related information into the shipment information database 120. Since the shipment information database 120 is linked to the Web server 130, it allows the freight forwarder 20 to promptly receive the delivery-related information and print the delivery-related information into a customs application document, thereby allowing the freight forwarder 20 to promptly submit the required customs application document to the authority.

When shipment notification is ready, the next step S3 is executed, in which the shipment management platform 110 is used to prepare and send the shipment notification in EDI856 form via the EDI platform 140 to the customer 30 and meanwhile download the EDI856-related information into the shipment information database 120. Since the shipment information database 120 is linked to the Web server 130, it allows the freight forwarder 20 to promptly receive the EDI856-related information and print the EDI856-related information into an exportation application document, thereby allowing the freight forwarder 20 to promptly submit the required exportation application document to authority.

In conclusion, the invention provides an online shipment information server system and method for use by a manufacturer to provide online shipment information to a freight forwarder, allowing the freight forwarder to receive online shipment information in real-time via Internet, without having to be mailed or faxed by the manufacturer to the freight forwarder. This allows the freight forwarder to execute the required custom/exportation application procedures more efficiently and reliably.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for providing online shipment information to a freight forwarder, comprising the steps of:
(1) generating a set of shipment information at each stage of shipment preparation;
(2) downloading the shipment information into a shipment information database;
(3) linking the shipment information database to a network server linked to a network system to allow the freight forwarder to gain access to the shipment information via the network system and through a browser program and print the shipment information into a set of customs/exportation application documents.

2. The method of claim 1, wherein in said step (1), the shipment information includes EDI855-related information, delivery-related information, and EDI856-related information.

3. The method of claim 1, wherein in said step (3), the network system is Internet.

4. The method of claim 3, wherein in said step (3), the network server is a Web server.

5. The method of claim 3, wherein in said sep (3), the browser program is Microsoft Internet Explorer.

6. The method of claim 3, wherein in said sep (3), the browser program is Netscape Navigator.

7. A method for providing online shipment information to a freight forwarder, comprising the steps of:
(1) generating a set of shipment information at each stage of shipment preparation, including EDI855-related information, delivery-related information, and EDI856-related information;
(2) downloading the shipment information into a shipment information database;
(3) linking the shipment information database to a Web server linked to Internet to allow the freight forwarder to gain access to the shipment information via Internet and through a Web browser program and print the shipment information into a set of customs/exportation application documents.

8. The method of claim 7, wherein in said sep (3), the Web browser program is Microsoft Internet Explorer.

9. The method of claim 7, wherein in said sep (3), the Web browser program is Netscape Navigator.

10. An online shipment information server system for providing online shipment information to a freight forwarder, which comprises:
(a) a shipment management platform, which is used to prepare a set of shipment information, including EDI855-related information, delivery-related information, and EDI856-related information;
(b) a shipment information database, which is used to store all the shipment information prepared by the shipment management platform; and
(c) a Web server, which is externally linked to Internet and internally linked to the shipment information database, for serving up the shipment information stored in the shipment information database via Internet to the freight forwarder, allowing the freight forwarder to view the shipment information through a Web browser program and print the shipment information into a set of customs/exportation application documents.

11. The online shipment information server system of claim 10, wherein the Web browser program is Microsoft Internet Explorer.

12. The online shipment information server system of claim 10, wherein the Web browser program is Netscape Navigator.
